(19) United States
(12) Patent Application Publication
(10) Pub. No.: US 2025/0113103 A1
(43) Pub. Date: Apr. 3, 2025

(54) IMAGE-BASED FOCUSING FOR AUTOFLUORESCENCE MICROSCOPY

(71) Applicant: Verily Life Sciences LLC, Dallas, TX (US)

(72) Inventors: Charles Santori, Palo Alto, CA (US); Michael Gutierrez, Indian Head Park, IL (US); Tadayuki Yoshitake, Foster City, CA (US)

(73) Assignee: Verily Life Sciences LLC, Dallas, TX (US)

(21) Appl. No.: 18/899,577

(22) Filed: Sep. 27, 2024

Related U.S. Application Data
(60) Provisional application No. 63/542,167, filed on Oct. 3, 2023.

(51) Int. Cl. H04N 23/67; G02B 21/16; G02B 21/24; G02B 21/36; G06T 7/00; G06T 7/11

(52) U.S. Cl. CPC H04N 23/676; G02B 21/16; G02B 21/244; G02B 21/365; G06T 7/0012; G06T 7/11; G06T 2207/10056; G06T 2207/10064; G06T 2207/20021; G06T 2207/30024

(57) ABSTRACT

A microscope can be focused to capture sharp images of different portions of a slide including a tissue sample. A focal position of the microscope objective to capture a sharp image for a portion of the slide can be determined based on multiple tissue autofluorescence images pre-captured corresponding to different focal positions. The pre-captured tissue autofluorescence images can be divided into multiple columns of image patches. The focal position for the portion of the slide can be determined based on sharpness metrics of the multiple columns of image patches.

### CROSS-REFERENCE TO RELATED APPLICATIONS

This application claims priority to U.S. Provisional Patent Application No. 63/542,167, filed Oct. 3, 2023, titled “IMAGE-BASED FOCUSING FOR AUTOFLUORESCENCE MICROSCOPY,” the entirety of which is hereby incorporated by reference.

### BACKGROUND

A microscope can image a large sample area by acquiring many smaller images (e.g., tiles) with specific sharpness across a sample area and stitching them together digitally to obtain an image of the entire sample area. The focal position for different portions of the large sample area may be adjusted in order to produce clear and sharp image tiles for different portions of the sample area.

### BRIEF SUMMARY

Various examples are described including systems, methods, and devices relating to image-based focusing for autofluorescence microscopy.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method. The computer-implemented method includes enabling a camera of a microscope to capture a first set of tissue autofluorescence images of a first portion of a slide at a plurality of distances from an objective of the microscope. The slide comprises an unstained tissue sample, and the slide is retained on a stage of the microscope. The computer-implemented method also includes dividing each of the first set of tissue autofluorescence images by a predetermined grid to generate multiple columns of image patches. Each column of image patches comprises image patches captured at the plurality of distances from the objective of the microscope. The computer-implemented method also includes selecting an image patch of a specific sharpness metric for each column of the multiple columns of image patches to obtain a set of image patches and a set of focal positions corresponding to the set of image patches. The computer-implemented method also includes determining a first focal position of the objective of the microscope for the first portion of the slide based on the corresponding set of focal positions. The computer-implemented method also includes adjusting a distance between the stage and the objective to the first focal position of the objective of the microscope. The computer-implemented method also includes enabling the camera of the microscope to capture a first image of the first portion of the slide when the objective of the microscope is at the first focal position.

Another general aspect includes a computer-implemented method. The computer-implemented method includes enabling a camera of a microscope to capture a first set of tissue autofluorescence images of a first portion of a slide at a plurality of distances from an objective of the microscope. The slide comprises an unstained tissue sample and the slide is retained on a stage of the microscope. The computer-implemented method also includes dividing each of the first set of tissue autofluorescence images by a predetermined grid to generate multiple columns of image patches. Each column of image patches comprises image patches captured at the plurality of distances from the objective of the microscope. The computer-implemented method also includes determining a sharpness pattern for each column of image patches captured at the plurality of distances from the objective of the microscope. The computer-implemented method also includes determining a first focal position of the objective of the microscope corresponding to a largest number of image patches with the specific sharpness metric among the multiple columns of image patches based on the sharpness pattern for each column of the multiple columns of image patches. The computer-implemented method also includes adjusting a distance between the stage and the objective corresponding to the first focal position of the objective of the microscope. The computer-implemented method also includes enabling the camera of the microscope to capture a first image of the first portion of the slide at the first focal position.

Another general aspect includes a computer-implemented method. The computer-implemented method includes determining a tissue region on a slide based on a pre-captured image of the slide. The slide comprises an unstained tissue sample includes a plurality of portions. The computer-implemented method also includes determining a first portion of the slide based on the tissue region to be scanned; enabling a camera of a microscope to capture a first set of tissue autofluorescence images of the first portion of the slide at a first plurality of distances from an objective of the microscope; determining a first focal position of the objective of the microscope for the first portion of the slide based on a first set of sharpness metrics for the first set of tissue autofluorescence images; and enabling the camera of the microscope to capture a first image of the first portion of the slide at the first focal position of the objective of the microscope. The computer-implemented method also includes determining a second portion of the slide to be scanned based on a location of the first portion; enabling the camera of the microscope to capture a second set of tissue autofluorescence images of the second portion of the slide at a second plurality of distances from the objective of the microscope; determining a second focal position for the second portion of the slide based on a second set of sharpness metrics for the second set of tissue autofluorescence images; and enabling the camera of the microscope to capture a second image of the first portion of the slide at the second focal position of the objective of the microscope.

Another general aspect includes a computer-implemented method. The computer-implemented method includes identifying a tissue region in a pre-captured image of a slide comprising an unstained tissue sample. The computer-implemented method also includes selecting multiple portions of the slide based on the tissue region; enabling a camera of a microscope to capture multiple sets of tissue autofluorescence images for the multiple portions of the slide respectively; and identifying multiple focal positions of an objective of the microscope for the multiple portions of the slide based on sharpness metrics of the multiple sets of tissue autofluorescence images respectively. The computer-implemented method also includes fitting a function to the multiple focal positions for the multiple portions of the slide. The function represents a relationship between a focal position of the objective of the microscope for each portion of the slide and a location of each portion of the slide. The computer-implemented method also includes using the function to enable capture of a plurality of image of a plurality of portions of the slide by at least adjusting a distance between each portion of the slide and an objective of a microscope to enable the objective of the microscope to be at a primary focal position for each portion of the slide determined from the function based on the location of each portion of the slide; and causing a camera to capture an image of each portion of the slide at the primary focal position of the objective of the slide.

Other embodiments of this aspect include corresponding computer systems, apparatus, and computer programs recorded on one or more computer storage devices, each configured to perform the actions of the methods.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 illustrates an example imaging system in which techniques relating to image-based focusing for autofluorescence microscopy may be implemented, according to at least one example.

FIG. 2 illustrates an example slide that may be imaged using the imaging system of FIG. 1, according to at least one example.

FIG. 3 illustrates an example graph of the power spectrum of a tissue fluorescence image as a function of tissue spatial frequencies under different exposure conditions, according to at least one example.

FIG. 4 illustrates example tissue autofluorescence images in a single microscope field of view, according to at least one example.

FIG. 5 illustrates an example graph of sharpness metric in a function of objective height from the tissue sample for three image patches of the example tissue autofluorescence image in FIG. 4, according to at least one example.

FIG. 6 illustrates an example flowchart depicting the process for determining a focal position of an objective of a microscope for capturing an image of a portion of a slide, according to at least one example.

FIG. 7 illustrates an example flowchart illustrating a process for determining a sharpness metric for an image, according to at least one example.

FIG. 8 illustrates an example flowchart illustrating a process for capturing images of an autofluorescence tissue sample, according to at least one example.

FIG. 9 illustrates an example flowchart illustrating another process for capturing images of an autofluorescence tissue sample, according to at least one example.

FIG. 10 illustrates examples of components of a computer system, according to at least one example.

### DETAILED DESCRIPTION

Examples are described herein in the context of image-based focusing for autofluorescence microscopy. Those of ordinary skill in the art will realize that the following description is illustrative only and is not intended to be in any way limiting. For example, the techniques described herein can be used to focus other microscopes, not just those used for autofluorescence microscopy. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

The techniques described herein may be used to adjust focal positions of a microscope objective for autofluorescence microscopy based on pre-captured images. For fluorescence microscopy of tissue sections, reliable and fast focusing is essential for obtaining sharp images while minimizing scan times. Any photobleaching of the sample caused by repeated measurements also needs to be minimized. Reliable focusing can be difficult in autofluorescence microscopy of unstained, non-cover-glassed samples. For this application, the fluorescence signals can be weak because of the low fluorescence efficiency of endogenous fluorophores, combined with constraints on the allowed exposure times and photobleaching levels. Focusing based on brightfield (transmission) images may also not be reliable. For formalin-fixed, paraffin-embedded (FFPE) tissue sections that have not been deparaffinized, the tissue is covered by a thin paraffin layer. The top of the paraffin may have a rough texture, or the paraffin may contain cracks, both of which present high-contrast signals in the brightfield image, but at an incorrect focal plane for imaging the tissue fluorescence. Even if fluorescence imaging is used for focusing, while the paraffin is largely invisible, brightly fluorescent debris may be present on top of the paraffin layer. An overly simple focusing method will likely focus on this debris instead of the tissue.

The techniques described herein are related to contrast-based focusing for tissue autofluorescence imaging. A suitable focal position for a sample region can be determined based on images pre-captured at different positions. The techniques include (1) finding a good sharpness metric that is compatible with the low signal levels, as needed to avoid photobleaching, (2) ignoring sparse, non-tissue features in nearby focal planes, such as the top of the paraffin layer, or the cover-glass surfaces if present, (3) choosing an appropriate set of focus positions for image acquisition, and (4) combining results from multiple focusing points across the tissue to obtain reliable focus position estimates in between.

Conventional imaging systems often employ specialized hardware for focusing. For example, phase-detection autofocusing splits the collected light to form separate images corresponding to light emitted at different angles. By estimating the translation between the images, a signal proportional to the focus offset can be obtained. As another example, laser-based focusing systems instead use a reflection from the sample surface to determine a focus offset. In both schemes, additional hardware may be required beyond the main imaging system, usually increasing the system complexity, footprint, and cost. Laser-based focusing may also be undesirable for samples where the target of interest is at an unknown height above or below the main reflecting surfaces. Therefore, it is advantageous to avoid using specialized hardware for focusing, especially for autofluorescence microscopy. The techniques described herein including contrast-based focusing may not require additional hardware components (besides the ability to move the microscope objective), has minimal calibration requirements, and may be the most direct method, since it maximizes the image quality in the same system used to collect the final data.

In an illustrative example, a digital microscope may be used to capture a set of images of a tissue sample retained on a slide (e.g., a glass slide). For one portion of the tissue sample (e.g., an area corresponding to the field of view of the camera), a computer system, either embodied in the imaging system or separate from the imaging system, may take or receive a set of tissue autofluorescence images pre-captured when the microscope object is at multiple different focal positions (e.g., different distances between the sample and the microscope objective). The set of pre-captured images can be divided into multiple columns of image patches. Each image patch corresponds to a sharpness metric and a focal position of the objective. A sharpness pattern is determined for each column of image patches as a function of focal positions. The image patch with the specific sharpness metric can be selected for each column of image patches to form a set of image patches with the specific sharpness metric at a set of focal positions. The optimal focal point for the portion of the slide can be determined based on the focal positions for the set of image patches. In this example, the optimal focal point for the portion of the slide may be the position of the microscope objective or the position of the slide where a sharp image of the portion of the slide can be obtained. The sharp image has clear contrast, bright details and dark background. The computer system can control the objective of the microscope to the optimal focal position and enable the camera of the microscope to acquire an image tile for the portion of the slide at the optimal focal position. The field of view of the microscope then moves to another portion of the slide (e.g., a movement in at least one of the X direction or the Y direction). The computer system determines an optimal focal position based on another set of pre-captured images for the other portion, and a clear and sharp image tile can be acquired for that portion when the objective is at the optimal focal position. This way, the computer system may determine an optimal focal position for the microscope to acquire a clear and sharp image for a portion as the field of view of the microscope moves from one portion to another. Alternatively, or additionally, the computer system can predetermine the optimal focal positions as a function of the location of different portions of the slide and acquire a clear and sharp image for each portion at corresponding optimal focal position.

The techniques described herein provide for improved results as compared to conventional focusing approaches. With contrast-based autofocus, no dedicated focusing hardware is required beyond the motor to move the emission microscope objective (and possibly an excitation objective as well, if illumination is through the back of the slide). A sharpness metric is optimized to work at low light levels to minimize photobleaching. Various techniques may be used to optimize the sharpness metric. For example, a majority-vote patch scheme can handle modest amounts of brightly fluorescent debris outside of the tissue focus plane to determine an autofocusing position at a specific field of view. A focus-as-you-go scheme can be combined with a limited fit radius to adapt to uneven surface topography or mechanical drifts during the scan of a tissue sample slide to obtain sample images. An up-front focusing scheme performs autofocus routine at selected locations to determine a fit function in advance of microscope imaging so that autofocusing frequency can be reduced. The techniques described herein can adjust the focusing of the microscope to produce sharp images without requiring additional hardware components or intricate calibration mechanisms for the microscope, and may be the most direct method to maximize the image quality in the same system.

This illustrative example is given to introduce the reader to the general subject matter discussed herein and the disclosure is not limited to this example. The following sections describe various additional non-limiting examples techniques relating to contrast-based focusing for tissue autofluorescence imaging.

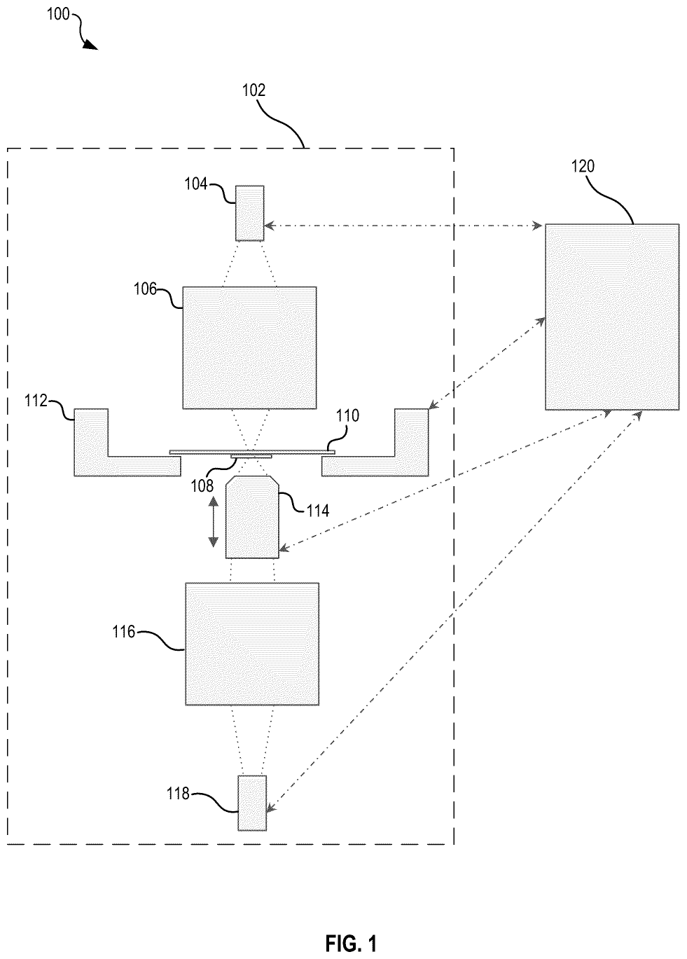

Turning now to the figures, FIG. 1 illustrates an example imaging system 100 in which techniques relating to image-based focusing for autofluorescence microscopy may be implemented, according to at least one example. The imaging system 100 includes a microscope 102 and a computer system 120. The microscope 102 includes illumination source 104 (e.g., LEDs), excitation optics 106 (lens and filters), XY precision stage 112, microscope objective 114 with Z actuation capability, emission optics 116 (lens and filters), image sensors 118 (cameras).

The imaging system 100 may be configured to image a sample 108, which in the illustrated example, may be held on a slide 110, such as a glass slide. The imaging system 100 images the exit face of a light guide to a plane close to the sample, but other configurations are possible, such as a Kohler illumination configuration. And masks (at a plane conjugate to the sample surface) may be used to limit the illumination area and reduce photobleaching.

The camera 118 may be any suitable device that includes at least one image sensor. In some examples, the camera 118 may have any suitable range of resolution and be capable of imaging any suitable wavelength of light. In some examples, the camera 118 may be suitable for imaging fluorescent wavelengths, though it may also image in other wavelengths.

In some examples, filters may also be included in the imaging system 100 to achieve design objectives. For example, there may be filters at the excitation optics 106 and the emission optics 116. The filter may be any suitable filter capable of altering the characteristics of the light that is seen by the sensor(s) of the camera 118. Thus, in some examples, the filter may be selected to enable the camera 118 to capture images of different wavelengths of light.

In some examples, the objective 114 may be an infinity-corrected objective together with the tube lens. In some examples, the objective 114 may be corrected for a fixed tube length (e.g., 160 mm) without a separate tube lens. In an automated example, a set of servo motor actuators (or other automated mechanisms) may be coupled with the objective 114 and electrically coupled with a controller. The controller may provide signals to the servo motor actuators to control movement of the servo motor actuators. In some examples, the controller may be included in, or otherwise be, the computer system 120. For example, the computer system 120 may provide electric signals to the servo motor actuators to cause the servo motor actuators to move the objective 114 to certain positions. In some examples, sensors and/or readouts may be connected to the objective 114 to provide positional information. In some examples, the positional information, either collected from the sensors or derived specifically from the servo motor actuators, may be used to perform the techniques described herein.

The XY precision stage 112 may be configured to retain the sample 108. The XY precision stage 112 may also be configured for movement in multiple axes with respect to the camera 118. For example, the XY precision stage 112 may be moved in an X direction and a Y direction (e.g., front to back and side to side along a plane parallel to the surface of the XY precision stage 112 on which the sample 108 is held). In some examples, the XY precision stage 112 may also be moveable in a Z direction (e.g., vertically with respect to the objective 114). Movement of the XY precision stage 112 may be manual or automated. In a manual example, a set of knobs and gears may be used to move the XY precision stage 112. Sensors and/or readouts, may be connected to the XY precision stage 112 in the manual example to provide a user with positional feedback of the relative position of the XY precision stage 112.

The illumination source 104 may include one or more lenses (not shown). The illumination source 104 is configured to provide light for imaging the slide 110. In some examples, properties of the illumination source 104 and the one or more lenses may be adjusted to achieve the particular imaging objectives of the system. For example, the illumination source 104 and the one or more lenses may be selected to provide fluorescent illumination of the sample 108.

In some examples, the imaging system 100 may support an illumination configuration that includes imaging a light emitting diode (LED) to a plane close to the sample plane, rather than using a light guide. In some examples, the imaging system 100 may support Kohler illumination, where the light source is imaged to a plane near the back focal plane of a condenser lens, or onto the condenser lens itself. Kohler illumination may improve the illumination uniformity for spatially inhomogeneous sources such as incandescent filaments or LEDs with structural features. In some examples, the described illumination configurations may incorporate a mask at a plane conjugate to the sample, to limit the illumination area to a region close to the detection area, thereby reducing unnecessary photobleaching of the sample.

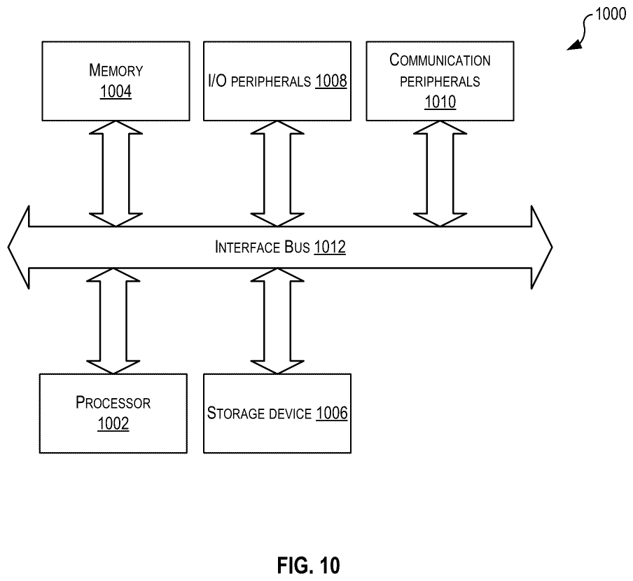

The computer system 120 may be any suitable computing device including a desktop computer, a server computer, a tablet, a laptop computer, a microprocessor and coupled memory, and any other suitable combination of the foregoing. In some examples, the computer system 120 may be integrally formed with the imaging system 100 and may include one or more ports for input/output components, such as a display, keyboard, keypad, mouse, and the like. In some examples, the computer system 120 may be configured to control the operation of the microscope 102 and/or perform techniques described herein relating to image-based focusing for autofluorescence microscopy. In some examples, the computer system 120 outputs information relating to the imaging system 100 (e.g., image data, state data for the illumination system 104, positional information of the XY precision stage 112, and any other suitable information), which is then processed by a different computer system for performing the techniques described herein. An example of components that may be included in the computer system 1000 is shown in FIG. 10.

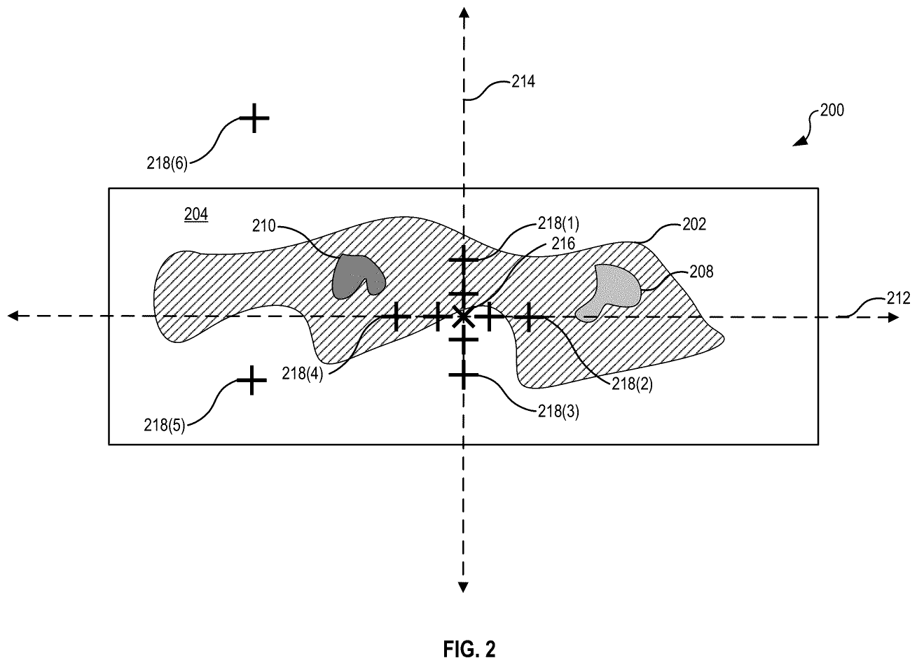

FIG. 2 illustrates an example slide 200 that may be imaged using the imaging system 100 of FIG. 1, according to at least one example. The slide 200 may be formed from any suitable material including, for example, glass, plastic, quartz, and any other suitable material. The slide 200 may have any suitable shape including rectangular, square, oval, round, and the like. The slide 200 may have any suitable dimension, which may be standard (e.g., 75 mm by 25 mm) or non-standard. The slide 200 may also be used with a cover slip or cover glass (not shown) to help retain a sample 202 on a slide surface 204 of the slide 200.

On the slide surface 204 is included a sample 202. The sample 202, which is an example of the sample 108, may be any suitable object to be imaged by the imaging system 100. In some examples, the sample 202 may be a tissue sample that has been obtained from a subject (e.g., a human). The sample 202 may include one or more distinct features 208 and 210. The feature 208 (e.g., a first feature) and the feature 210 (e.g., a second feature) may represent aspects of the sample 202 that are distinct or otherwise more highly visible under certain conditions.

FIG. 2 includes an X axis 212 and a Y axis 214 extending parallel to the slide surface 204 of the slide 200. The X axis 212 and the Y axis 214 are included for illustrative purposes to explain how the position of the slide 200 may be moved (e.g., on the XY precision stage 112) to capture images of the slide 200 at different positions. The slide 200 is illustrated at a centered position depicted by a center marker 216 (e.g., centered at an origin of the X axis 212 and the Y axis 214). Thus, at the centered position (0, 0), an image captured of the slide 200 would be focused and centered on the center marker 216. While the XY precision stage 112 and the slide 200 are moved, orientation and position of the camera remain fixed on the center marker 216.

A number of other positional markers 218 are also illustrated in FIG. 2. A few of these positional markers 218 are also labeled. The positional markers 218 are illustrative of other positions to which the slide can be moved relative to the microscope objective 114. For example, the slide 200 can be moved laterally along the Y axis 214 to positional marker 218(1), e.g., (0, +y) and 218(3), e.g., (0, −y). The slide 200 can also be moved laterally along the X axis 212 to positional markers 218(2), e.g., (+x, 0) and 218(4), e.g., (−x, 0). In some examples, the slide 200 can also be moved in both the X and Y directions, e.g., as illustrated by positional markers 218(5) and 218(6), while remaining on the slide surface 204 (e.g., 218(5) and off of the slide surface 204 (e.g., 218(6)). While a few positional markers are illustrated, it should be understood that the slide 200 may be moved to any suitable position relative to the microscope objective. Meanwhile, it should be understood that the microscope objective can also be moved laterally to a suitable position relative to the slide.

As the positional markers 218 are included for illustrative purposes, these markers are not to scale. In practice, the image shifts between positions may be much smaller than those illustrated by the positional markers 218. For example, the camera field of view may be much smaller than the sample, such that movements of the field of view remain on the sample 202.

In some examples, one or more images may be captured in each position. The positions may be predetermined, randomly assigned within some bounding, and/or any suitable combination of the foregoing. In some examples, the positions may include larger displacements and smaller displacements. The smaller displacements may be suitable for capturing information on structure of the sample 202 and the larger displacements may be suitable for generating information useful for determining large scale variation of the imaging system. In a particular example, a set of positions, in pixel units (x, y) may include {(0, 0), (0, 118), (0, −118), (118, 0), (−118, 0), (0, 1000), (0, −1000), (1000, 0), (−1000, 0)}.

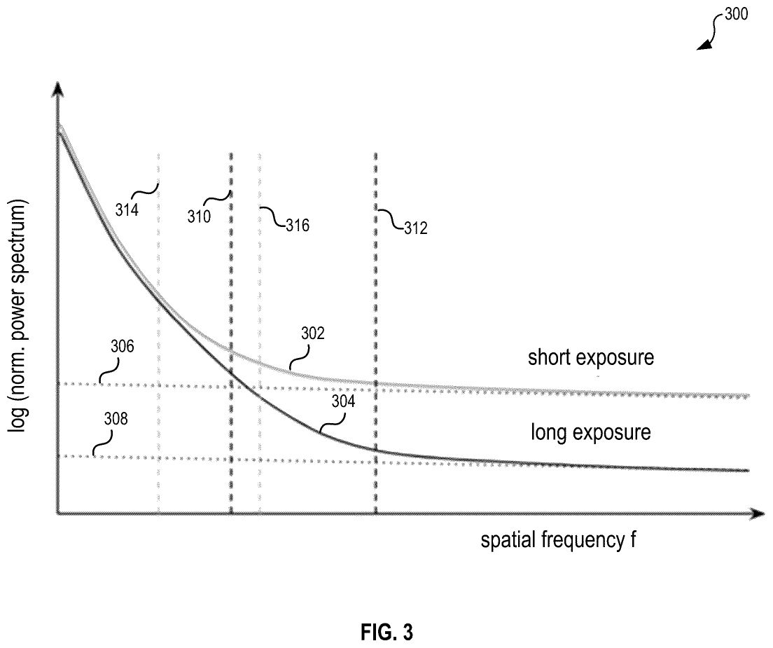

FIG. 3 illustrates an example graph 300 of the power spectrum of a tissue fluorescence image as a function of tissue spatial frequencies under different exposure conditions, according to at least one example. The spatial structure of tissue typically shows a continual decrease in signal power as a function of increasing spatial frequency, up to the maximum spatial frequency measured by an optical system, as illustrated by curves 302 and 304. At the same time, to limit photobleaching of the tissue sample, it may be desirable to set the excitation dose per exposure to a low level. At such low excitation doses, the signal at the highest spatial frequencies may be dominated by noise sources. The main noise sources are shot noise associated with the photoelectrons (or dark current) as well as sensor readout noise. On the other hand, lower-spatial-frequency signals are less sensitive to small changes in the focus position. Therefore, a sharpness metric sensitive to intermediate spatial frequencies may give the best combination of focus sensitivity and signal-to-noise ratio. The frequency cutoffs should be adjusted based on the noise levels, as illustrated in FIG. 3. In FIG. 3 the power spectrum of the image (or the image intensity) is normalized by the exposure time. The horizontal dotted lines 306 and 308 represent the detection noise levels for short and long exposures respectively. Vertical lines 310 and 312 define the low and high frequency cutoffs for a detection band that might be used to estimate sharpness with a long exposure. Vertical lines 314 and 316 define low and high frequency cutoffs for a detection band that might give a better sharpness estimate with a short exposure.

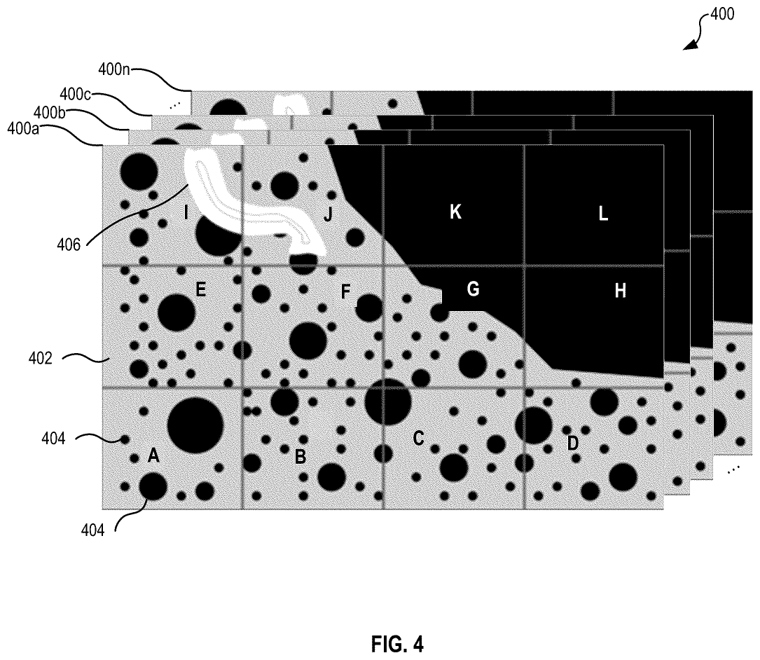

FIG. 4 illustrates example tissue autofluorescence images 400 in a single microscope field of view, according to at least one example. The example tissue autofluorescence images 400, including images 400a, 400b, 400c, . . . , 400n, can be images of a portion of the slide 200 in FIG. 2. The images 400 or the portion of the slide 200 corresponds to the field of view of the microscope in the image system 100. In other words, the images 400 can be acquired with different microscope objective positions with the same stage location (x,y). Each of the example tissue fluorescence images 400 can be considered as an image tile, and there can be multiple image tiles corresponding to multiple portions of the slide 200. Each of the example tissue autofluorescence images 400 can be divided in by a grid to multiple image patches. For example, image 400a is divided by a 4 by 3 grid into 12 patches, patches A, B, C, D, E, F, G, H, I, J, K, L. The gray region 402 in the example tissue autofluorescence image 400 represents tissue. The tissue also contains numerous vesicles 404 with sharp edges that can create useful sharpness signals for focusing on the tissue plane. A bright debris particle 406 may also be on the tissue or on top of a paraffin layer above the tissue. The multiple tissue autofluorescence images 400 of the same portion of the slide can be divided by a grid, such as a 4 by 3 grid as illustrated in FIG. 3, to create columns of image patches. For example, there can be 12 columns of image patches A, B, C, D, E, F, G, H, I, J, K, and L, created from the multiple tissue autofluorescence image 400 by a 4 by 3 grid.

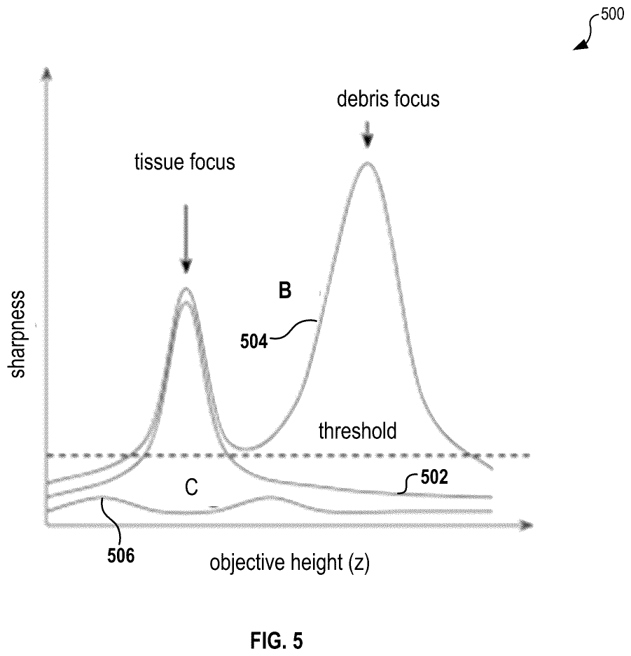

FIG. 5 illustrates an example graph 500 of sharpness metric in a function of objective height from the tissue sample for three image patches of the example tissue autofluorescence image 400 in FIG. 4, according to at least one example. Image patch B in FIG. 4 contains only tissue and presents a clear sharpness peak at the tissue focus plane. The sharpness metrics of patch B is illustrated by curve 502 as a function of objective heights. Image patch labeled I can present an additional, higher sharpness peak at a higher microscope objective position because of the bright debris particle 406. The sharpness of patch I is illustrated by curve 504 as a function of objective heights, which includes two sharpness peaks. Patches such as patch I are rare and can be excluded using majority voting-type schemes. At the same time, patch L, which does not contain any tissue, may present weak sharpness peaks at intermediate focal positions where defocused signal from the tissue spreads into the patch. The sharpness of patch L is illustrated by curve 506 as a function of objective heights. Patches like patch L should be excluded using an intensity or sharpness threshold since they might be numerous.

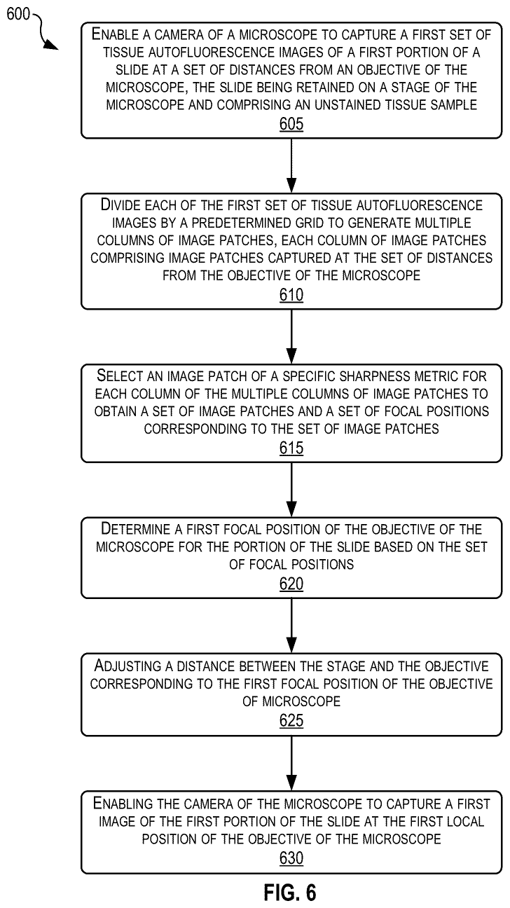

FIGS. 6-9 illustrate example flow diagrams showing processes 600, 700, 800, and 900, according to at least a few examples. These processes and any other processes described herein are illustrated as logical flow diagrams, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer readable storage medium, for example, in the form of a computer program including a set of instructions executable by one or more processors.

FIG. 6 illustrates an example flowchart depicting the process 600 for determining a focal position of an objective of a microscope for capturing an image of a portion of a slide, according to at least one example. The process 600 may be performed by the computer system 120 (e.g., a computer system 1000). The process 600 in particular is directed to capturing an image for a portion of a slide using the imaging system 100 when the objective of the microscope is at the focal position after determining the focal position based on a set of focal positions corresponding to image patches with specific sharpness metrics of multiple columns of image patches.

The process 600 begins at block 605 by the computer system 120 enabling a camera of a microscope to capture a first set of tissue autofluorescence images of a first portion of a slide at a set of distances from an objective of the microscope. The slide comprises an unstained tissue sample and the slide is retained on a stage of the microscope. In some examples, an unstained tissue sample is one that has not been treated with any histological stains typically used to highlight important tissue features and enhance contrast. However, in some examples, any exogenous substance (e.g., paraffin, tissue process solution etc.) can have some level of fluorescence, so the tissue sample may be seen as “stained” if it includes such exogenous substance. If fluorescence from any exogenous substance is small enough not to compromise tissue autofluorescence imaging, the tissue sample can be considered as “unstained.” Thus, the tissue sample or slide may avoid getting thin stains either intentionally (e.g., to make tissue easier to see by naked eye during sectioning), or accidentally (e.g. contamination). The microscope objective-to-sample distance can be controlled with sub-micron precision, for example by mounting the microscope objective on various types of motors. The excitation and exposure of the camera can also be controlled to obtain images when needed. The unstained tissue is autofluorescent, and the slide of the unstained tissue sample can be divided into multiple portions based on the field of view of the microscope. The first set of tissue autofluorescence images can be acquired at multiple regularly spaced focal positions of the objective of the microscope with a fixed interval, for example, between 10 micrometers and 25 micrometers. In other words, the first set of tissue autofluorescence images can be captured when the slide is at different distances from the objective of the microscope.

At block 610, the process 600 includes the computer system 120 dividing each of the first set of tissue autofluorescence images by a predetermined grid to generate multiple columns of image patches. Each column of image patches includes image patches captured at the set of distances from the objective of the microscope. For example, the predetermined grid is 4 by 3 (4×3) and the first set of tissue autofluorescence images have a resolution of 4000 by 3000 pixels. The first set of tissue autofluorescence images can be divided into 12 columns of image patches with 1000 by 1000 pixels.

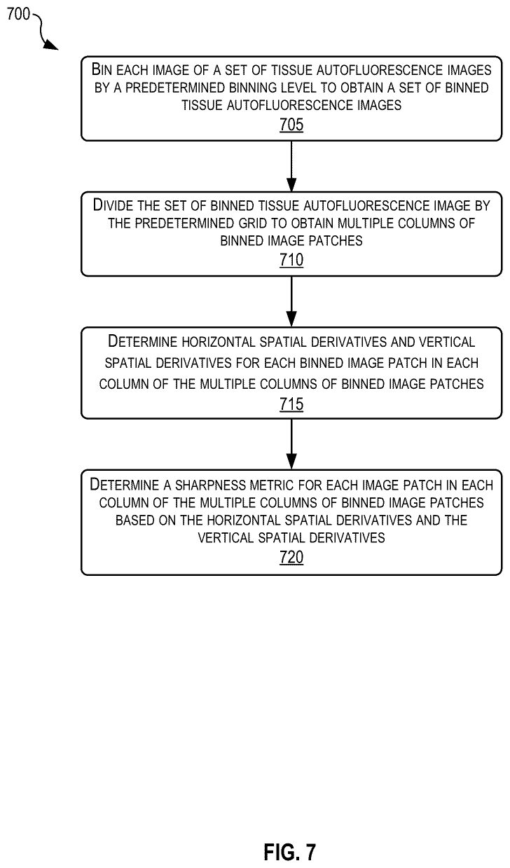

At block 615, the process 600 includes the computer system 120 selecting an image patch of a specific sharpness metric for each column of the multiple columns of image patches to obtain a set of image patches and a set of focal positions corresponding to the set of image patches. In some examples, the computer system 120 selects the image patch of a maximum sharpness metric for each column of the multiple columns of image patches to obtain the set of image patches and the set of focal positions corresponding to the set of image patches. In some examples, prior to selecting the image patch of the specific sharpness metric for each column of image patches, certain image patches with a brightness below a threshold are excluded. A sharpness metric can be calculated for each image in each column of the multiple columns of image patches, as will be described in FIG. 7. For each column, an image patch with the specific sharpness metric can be selected to form a set of image patches. Each of such image patches corresponds to a focal position of the objective of the microscope. The focal position of the objective of the microscope can be a distance between the stage where the slide is located and the objective of the microscope. The specific sharpness metric may change drastically for different columns of patches depending on tissue type, imaging conditions, illuminations etc. Selecting patches by comparing image patches in a column can avoid background patches being selected and correctly choose tissue for focusing, even if tissue samples have different levels of background signal.

At block 620, the process 600 includes the computer system 120 determining a first focal position of the objective of the microscope for the first portion of the slide based on the corresponding set of focal positions. The first focal position is considered as an optimal focal position, where a clear and sharp image of the first portion of the slide can be captured. In some examples, a mode of the set of focal positions corresponding to the set of image patches with the maximum sharpness metrics is determined to be a focal position of the objective of the microscope for capturing an image for the first portion of the slide. In some examples, a median of the set of focal positions corresponding to the set of image patches with the maximum sharpness metrics is determined to be a focal position of the objective of the microscope for capturing an image for the first portion of the slide. In some examples, the first focal position corresponds to the largest number of image patches with maximum sharpness from the multiple columns of image patches based on sharpness patterns of the multiple columns of image patches. The sharpness pattern can be a fit function for the sharpness metrics for each column of image patches.

At block 625, the process 600 includes the computer system 120 adjusting a distance between the stage and the objective to the first focal position of the objective of the microscope. In some examples, the stage of the microscope is connected with a motor actuator, which can be controlled by the computer system 120 to move the stage of the microscope. In some examples, the objective of the microscope is connected with a motor actuator, which can be controlled by the computer system 120 to move the objective of the microscope. In some examples, each of the stage and the objective is connected with a motor actuator. The position of the stage of the microscope, the position of the objective of the microscope, or both can be adjusted to adjust the distance between the stage and the objective of the microscope so that the objective of the microscope is at the first focal position obtained at block 620.

At block 630, the process 600 includes the computer system 120 enabling the camera of the microscope to capture a first image of the first portion of the slide when the objective of the microscope is at the first focal position. The first image of the first portion of the slide has a specific sharpness metric, as it is captured when the objective of the microscope is at the first focal position determined at block 620, which is an optimal focal position for the first portion of the slide.

FIG. 7 illustrates an example flowchart illustrating a process for determining a sharpness metric for an image, according to at least one example. The process 700 may be performed by the computer system 120 (e.g., a computer system 1000). The process 700 in particular is directed to determining a sharpness metric for an image based on spatial derivatives after the image is binned.

The process 700 begins at block 705 by the computer system 120 binning each image of a set of tissue autofluorescence images by a predetermined binning level to obtain a set of binned tissue autofluorescence images. The binning level can be denoted as b, and an image resolution can be represented by Nₓ by N_{y}. For example, the binning level is 4. Each image, for example with a resolution of 4000 by 3000 pixels, can be divided into 1000 by 750 groups with 4 by 4 pixels. Each image thus has 750,000 elements (groups). The average intensity for each group can be calculated, which can be used for determining the sharpness of the image later. Thus, a set of tissue fluorescence images can be binned to obtain a first set of binned tissue autofluorescence images. This binning procedure serves as a computationally inexpensive low-pass filter. It also reduces subsequent computational costs by reducing the image size by a factor of b², which is 16 in this example where b is 4.

At block 710, the process 700 includes the computer system 120 dividing the set of binned tissue autofluorescence images by a predetermined grid to obtain multiple columns of binned image patches. Similar to block 610, the set of binned tissue autofluorescence images can be divided into multiple columns of binned image patches by a predetermined grid. For example, the grid is 4 by 3 and each binned tissue autofluorescence image has 1000 by 750 elements. The set of tissue autofluorescence images can be divided into 12 columns of binned image patches with 250 by 250 elements.

At block 715, the process 700 includes the computer system 120 determining horizontal spatial derivatives and vertical spatial derivatives for each binned image patch in each column of the multiple columns of binned image patches. Spatial differences along the x-axis and the y-axis can be computed, which are also called spatial differences, spatial derivatives, or first derivatives. The horizontal spatial derivative, or the spatial derivative at pixel [x,y] along the x-axis can be obtained by taking the difference between the pixel value at pixel [x+1,y] and the pixel value at pixel [x,y]. Similarly, the vertical spatial derivative, or the spatial derivative at pixel [x,y] along the y-axis can be obtained by taking the difference between the pixel value at pixel [x,y+1] and the pixel value at pixel [x,y]. For binned image patches, the horizontal and vertical spatial derivatives can be derived at each element (group) obtained at block 705. The spatial derivatives can serve as a high-pass filter.

At block 720, the process 700 includes the computer system 120 determining a sharpness metric for each image patch in each column of the multiple columns of binned image patches based on the horizontal spatial derivatives and the vertical spatial derivatives. The standard deviation for horizontal spatial derivatives and standard deviation for vertical spatial derivatives can be calculated to determine a sharpness metric. For example, the sharpness metric is a combined standard deviation σ_{b}=√[std(Iₓ)²+std(I_{y})²]), where std(Iₓ) is standard deviation along x axis and std(I_{y}) is the standard deviation along y axis. Alternatively, other forms of derivatives or other image attributes can be used to create the sharpness metric. An image with a good sharpness metric value can display bright details of a subject (e.g., a tissue sample) against a dark background.

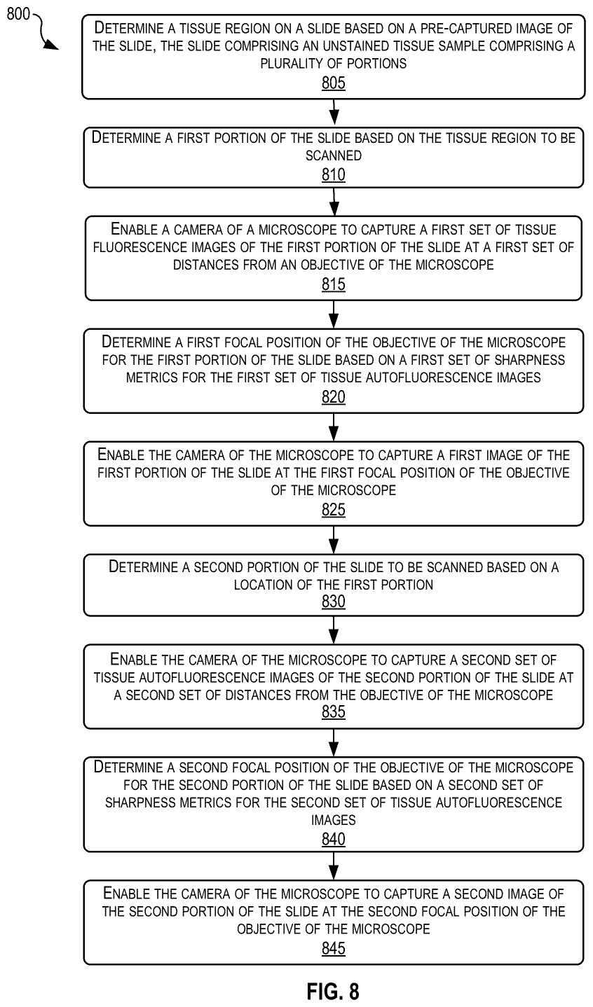

FIG. 8 illustrates an example flowchart illustrating a process for capturing images of an autofluorescence tissue sample, according to at least one example. The process 800 may be performed by the computer system 120 (e.g., a computer system 1000). The process 700 in particular is directed to a focus-as-you-go scheme for determining focal positions and capturing sharp images for different portions of a slide.

The process 800 begins at block 805 by the computer system 120 determining a tissue region on a slide based on a pre-captured image of the slide. The slide includes an unstained tissue sample comprising a set of portions. In some examples, a coarse image of the slide can be pre-captured by a low-resolution camera. A tissue region can be detected in the coarse image by image processing.

At block 810, the process 800 includes the computer system 120 determining a first portion of the slide based on the tissue region to be scanned. In some examples, the coarse image can be divided into multiple image tiles based on the field of view of the microscope objective. For each image tile, a product of a distance from the tissue edge and the local brightness of the image tile can be determined to be a scan metric for selecting portions of the slide for scanning. The first portion corresponds to the image tile of the maximum scan metric. In some examples, the first portion of the slide for scanning is selected from the middle of the tissue region determined at block 805. In some examples, the first portion is a portion on one end of the slide.

At block 815, the process 800 includes the computer system 120 enabling a camera of a microscope to capture a first set of tissue autofluorescence images of the first portion of the slide at a first set of distances from an objective of the microscope. The first set of issue autofluorescence images of the first portion of the slide can be captured at different distances from the objective of the microscope, generally as described at block 605. For example, the first set of tissue autofluorescence images can be acquired at multiple regularly spaced focal positions of the objective of the microscope with a fixed interval, for example, 10 micrometers or 25 micrometers.

At block 820, the process 800 includes the computer system 120 determining a first focal position of the objective of the microscope for the first portion of the slide based on a first set of sharpness metrics for the first set of tissue autofluorescence images. The first focal position for the first portion of the slide can be determined based on a first set of sharpness metrics corresponding to the first set of distances at block 815, generally as described in FIG. 6. The sharpness metrics can be determined generally as described in FIG. 7. The first focal position can be considered to be an optimal focal position of the objective of the microscope for capturing a sharp image of the first portion of the slide.

At block 825, the process 800 includes the computer system 120 enabling the camera of the microscope to capture a first image of the first portion of the slide at the first focal position of the objective of the microscope. The first image captured when the objective of the microscope is at the first local position is a sharp image that can clearly present the tissue features in the first portion of the slide.

At block 830, the process 800 includes the computer system 120 determining a second portion of the slide to be scanned based on a location of the first portion. In some examples, a scan metric is determined as described at block 810. An unscanned portion that corresponds to an image tile with the highest scan metric is selected as the second portion. Subsequent portions can be selected similarly based on the scan metric. The subsequent portions generally follow a spiral pattern. In some examples, the second portion is an adjacent or neighboring portion to the first portion. If there are no unscanned neighboring portions left, the nearest portion that is not a neighbor can be selected as the second portion. In some examples, subsequent portions follow a zig-zag pattern when the first portion is on one end of the slide.

At block 835, the process 800 includes the computer system 120 enabling the camera of the microscope to capture a second set of tissue autofluorescence images of the second portion of the slide at a second c of distances from the objective of the microscope. The second set of tissue autofluorescence images of the second portion of the slide can be captured at a second set of distances from the objective of the microscope, similar to how the first set of tissue autofluorescence images are captured as described at block 815. However, the second set of distances are generally in a smaller range than the range for the first set of distances corresponding to the first set of tissue autofluorescence images. In some examples, the second set of distances are adjusted based on the first focal position determined at block 820. A smaller step size can be used to adjust the distance between the objective of the microscope and the stage of the microscope around the first focal position to obtain the second set of distances.

At block 840, the process 800 includes the computer system 120 determining a second focal position for the second portion of the slide based on a second set of sharpness metrics for the second set of tissue autofluorescence images. The second focal position for the second portion of the slide can be determined based on a second set of sharpness metrics corresponding to the first set of distances at block 835, generally as described in FIG. 6. The sharpness metrics can be determined generally as described in FIG. 7. The second focal position can be considered as an optimal focal position of the objective of the microscope for capturing a sharp image of the second portion of the slide.

At block 845, the process 800 includes the computer system 120 enabling the camera of the microscope to capture a second image of the first portion of the slide at the second focal position of the objective of the microscope. The second image captured when the objective of the microscope is at the second local position is a sharp image that can clearly present the tissue features in the second portion of the slide.

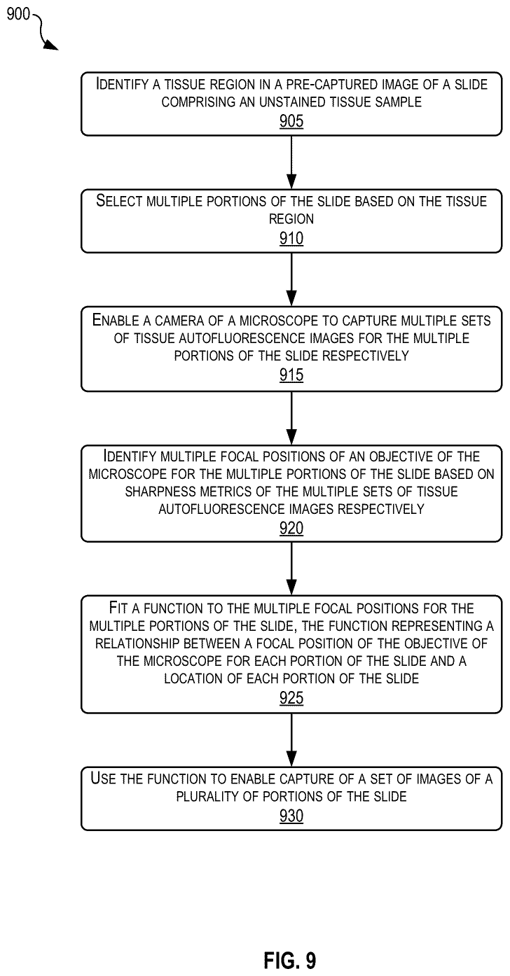

FIG. 9 illustrates an example flowchart illustrating another process for capturing images of an autofluorescence tissue sample, according to at least one example. The process 900 may be performed by the computer system 120 (e.g., a computer system 1000). The process 800 in particular is directed to an upfront focusing scheme for capturing sharp images of different portions of a slide.

The process 900 begins at block 905 by the computer system 120 identifying a tissue region in a pre-captured image of a slide comprising an unstained tissue sample. In some examples, a coarse image of the slide can be pre-captured by a low-resolution camera. A tissue region can be detected in the coarse image by image processing.

At block 910, the process 900 includes the computer system 120 selecting multiple portions of the slide based on the tissue region. The multiple portions of the slide can be a sparse set of portions that evenly spread across the tissue area.

At block 915, the process 900 includes the computer system 120 enabling a camera of a microscope to capture multiple sets of tissue autofluorescence images for the multiple portions of the slide respectively. For each portion selected at block 910, a set of tissue autofluorescence images can be captured at multiple distances from an objective of the microscope, generally as described at block 605 in FIG. 6.

At block 920, the process 900 includes the computer system 120 identifying multiple focal positions of an objective of the microscope for the multiple portions of the slide based on sharpness metrics of the multiple sets of tissue autofluorescence images respectively. For each portion of the slide, a focal position can be determined based on the sharpness metrics of the corresponding set of tissue autofluorescence images, generally as described in FIG. 6. The sharpness metrics can be determined generally as described in FIG. 7.

At block 925, the process 900 includes the computer system 120 fitting a function to the multiple focal positions for the multiple portions of the slide. The function represents a relationship between a focal position of the objective of the microscope for each portion of the slide and a location of each portion of the slide.

At block 930, the process 900 includes the computer system 120 using the function to enable capture of a set of images of a set of portions of the slide. Based on the function obtained at block 925, a primary focal position of an objective of the microscope for a portion of the slide can be obtained corresponding to the location of the portion of the slide. The distance between each portion of the slide and an objective of a microscope can be adjusted to enable the objective of the microscope to be at the primary focal position for each portion of the slide. The camera of the microscope can capture an image of each portion of the slide with the objective of the slide at the corresponding primary focal position. The fit function can be adjusted during the main scan of the slide.

The process 800 in FIG. 8 can be considered as a focus-as-you-go approach, where the computer system determines an optimal focal position for a portion of the slide and the microscope captures an image for the portion, and then the process moves to the next portion. The process 900 in FIG. 9 can be considered as an upfront approach, where a fit function of optimal focal positions is determined for a slide, and then different portions of the slide can be scanned to capture images based on the optimal focal positions obtained from the fit function. In some examples, a combination of process 800 and process 900 can be used for scanning a slide. The first few portions can be scanned in a scan-as-you-go approach as described in process 800 in FIG. 8. Then a fit function can be determined based on the optimal focal positions for the first few scanned portions. The optimal focal positions for the rest of the portions can be determined based on the fit function for scanning.

FIG. 10 illustrates examples of components of a computer system 1000, according to at least one example. The computer system 1000 may be a single computer such as a user computing device and/or can represent a distributed computing system such as one or more server computing devices. The computer system 1000 is an example of the computing system 120.

The computer system 1000 may include at least a processor 1002, a memory 1004, a storage device 1006, input/output peripherals (I/O) 1008, communication peripherals 1010, and an interface bus 1012. The interface bus 1012 is configured to communicate, transmit, and transfer data, controls, and commands among the various components of the computer system 1000. The memory 1004 and the storage device 1006 include computer-readable storage media, such as Random Access Memory (RAM), Read ROM, electrically erasable programmable read-only memory (EEPROM), hard drives, CD-ROMs, optical storage devices, magnetic storage devices, electronic non-volatile computer storage, for example Flash® memory, and other tangible storage media. Any of such computer-readable storage media can be configured to store instructions or program codes embodying aspects of the disclosure. The memory 1004 and the storage device 1006 also include computer-readable signal media. A computer-readable signal medium includes a propagated data signal with computer-readable program code embodied therein. Such a propagated signal takes any of a variety of forms including, but not limited to, electromagnetic, optical, or any combination thereof. A computer-readable signal medium includes any computer-readable medium that is not a computer-readable storage medium and that can communicate, propagate, or transport a program for use in connection with the computer system 1000.

Further, the memory 1004 includes an operating system, programs, and applications. The processor 1002 is configured to execute the stored instructions and includes, for example, a logical processing unit, a microprocessor, a digital signal processor, and other processors. The memory 1004 and/or the processor 1002 can be virtualized and can be hosted within another computing system of, for example, a cloud network or a data center. The I/O peripherals 1008 include user interfaces, such as a keyboard, screen (e.g., a touch screen), microphone, speaker, other input/output devices, and computing components, such as graphical processing units, serial ports, parallel ports, universal serial buses, and other input/output peripherals. The I/O peripherals 1008 are connected to the processor 1002 through any of the ports coupled to the interface bus 1012. The communication peripherals 1010 are configured to facilitate communication between the computer system 1000 and other computing devices over a communications network and include, for example, a network interface controller, modem, wireless and wired interface cards, antenna, and other communication peripherals.

In the following, further examples are described to facilitate the understanding of the present disclosure.

Example 1. In this example, there is provided a computer-implemented method, including:

enabling a camera of a microscope to capture a first set of tissue autofluorescence images of a first portion of a slide at a plurality of distances from an objective of the microscope, wherein the slide comprises an unstained tissue sample, wherein the slide is retained on a stage of the microscope;

dividing each of the first set of tissue autofluorescence images by a predetermined grid to generate multiple columns of image patches, wherein each column of image patches comprises image patches captured at the plurality of distances from the objective of the microscope;

selecting an image patch of a specific sharpness metric for each column of the multiple columns of image patches to obtain a set of image patches and a set of focal positions corresponding to the set of image patches;

determining a first focal position of the objective of the microscope for the first portion of the slide based on the corresponding set of focal positions;

adjusting a distance between the stage and the objective to the first focal position of the objective of the microscope; and

enabling the camera of the microscope to capture a first image of the first portion of the slide when the objective of the microscope is at the first focal position.

Example 2. In this example, there is provided a computer-implemented method of example 1, wherein selecting an image patch of a specific sharpness metric for each column of the multiple columns of image patches to obtain a set of image patches and a set of focal positions corresponding to the set of image patches comprises:

selecting an image patch of a maximum sharpness metric for each column of the multiple columns of image patches to obtain the set of image patches and the set of focal positions corresponding to the set of image patches.

Example 3. In this example, there is provided a computer-implemented method of example 2, further including:

binning each image of the first set of tissue autofluorescence images by a predetermined binning level to obtain a first set of binned tissue autofluorescence images;

dividing the first set of binned tissue autofluorescence images by the predetermined grid to obtain multiple columns of binned image patches;

determining horizontal spatial derivatives and vertical spatial derivatives for each binned image patch in each column of the multiple columns of binned image patches; and

determining a sharpness metric for each image patch in each column of the multiple columns of binned image patches based on the horizontal spatial derivatives and the vertical spatial derivatives.

Example 4. In this example, there is provided a computer-implemented method of example 3, further including:

determining a spatial frequency range for each binned image based on an exposure time; and

determining the horizontal spatial derivatives and vertical spatial derivatives based on spatial differences horizontally and vertically in each binned image.

Example 5. In this example, there is provided a computer-implemented method of example 3, wherein the sharpness metric is based on standard deviations of the horizontal spatial derivatives and the vertical spatial derivatives.

Example 6. In this example, there is provided a computer-implemented method of example 3, further including:

determining a sharpness pattern for each column of the multiple columns of image patches at the plurality of distances from the objective of the microscope based on the sharpness metric for each image patch in a corresponding column of the multiple columns of image patches.

Example 7. In this example, there is provided a computer-implemented method of example 6, wherein determining a sharpness pattern for each column of the multiple columns of image patches captured at the plurality of distances from the objective of the microscope based on the sharpness metric for each image patch in a corresponding column of the multiple columns of image patches comprises:

fitting a function to the sharpness metric for each image patch in the corresponding column of the multiple columns of image patches.

Example 8. In this example, there is provided a computer-implemented method of example 6, wherein selecting an image patch of a specific sharpness for each column of the multiple columns of image patches to obtain a set of image patches at a corresponding set of focal positions comprises excluding image patches having a corresponding sharpness pattern that comprises more than one sharpness peak.

Example 9. In this example, there is provided a computer-implemented method of example 1, further including:

prior to selecting an image patch of a specific sharpness metric for each column of the multiple columns of image patches to obtain a set of image patches at a corresponding set of focal positions:

excluding image patches from the multiple columns of image patches with a brightness below a threshold.

Example 10. In this example, there is provided a computer-implemented method of example 1, wherein determining a first focal position for the first portion of the slide based on the corresponding set of focal positions comprises:

determining a mode of the corresponding set of focal positions to be the first focal position for the first portion of the slide.

Example 11. In this example, there is provided a computer-implemented method of example 1, wherein determining a first focal position for the first portion of the slide based on the corresponding set of focal positions comprises:

determining a median of the corresponding set of focal positions to be the first focal position for the first portion of the slide.

Example 12. In this example, there is a provided computer-implemented method of example 1, wherein the stage of the microscope is connected with a motor actuator, and wherein adjusting a distance between the stage and the objective corresponding to the first focal position of the objective of the microscope comprises causing the motor actuator to move the stage of the microscope to the first focal position of the objective of the microscope.

Example 13. In this example, there is provided a computer-implemented method of example 1, wherein the objective of the microscope is connected with a motor actuator, and wherein adjusting a distance between the stage and the objective corresponding to the first focal position of the objective of the microscope comprises causing the motor actuator to move the objective of the microscope so that the slide on the stage is at the first focal position of the objective of the microscope.

Example 14. In this example, there is provided a non-transitory computer-readable storage device comprising computer-executable instructions that, when executed by a computer system, cause the computer system to perform the method of any of examples 1-13.

Example 15. In this example, there is provided a computer system, including:

a memory configured to store computer-executable instructions; and

a processor configured to access the memory and execute the computer-executable instructions to perform the method of examples 1-13.

Example 16. In this example, there is provided a computer-implemented method, including:

enabling a camera of a microscope to capture a first set of tissue autofluorescence images of a first portion of a slide at a plurality of distances from an objective of the microscope, wherein the slide comprises an unstained tissue sample, wherein the slide is retained on a stage of the microscope;

dividing each of the first set of tissue autofluorescence images by a predetermined grid to generate multiple columns of image patches, wherein each column of image patches comprises image patches captured at the plurality of distances from the objective of the microscope;

determining a sharpness pattern for each column of image patches captured at the plurality of distances from the objective of the microscope;

determining a first focal position of the objective of the microscope corresponding to a largest number of image patches with specific sharpness metrics among the multiple columns of image patches based on the sharpness pattern for each column of the multiple columns of image patches;

adjusting a distance between the stage and the objective corresponding to the first focal position of the objective of the microscope; and

enabling the camera of the microscope to capture a first image of the first portion of the slide at the first focal position.

Example 17. In this example, there is provided a computer-implemented method of example 16, wherein determining a first focal position of the objective of the microscope corresponding to a largest number of image patches with specific sharpness metrics among the multiple columns of image patches based on the sharpness pattern for each column of the multiple columns of image patches comprises:

determining the first focal position of the objective of the microscope corresponding to the largest number of image patches with maximum sharpness metrics among the multiple columns of image patches based on the sharpness pattern for each column of the multiple columns of image patches.

Example 18. In this example, there is provided a computer-implemented method of example 16, further including:

binning each image of the first set of tissue autofluorescence images by a predetermined binning level to obtain a first set of binned tissue autofluorescence images;

dividing the first set of binned tissue autofluorescence images by the predetermined grid to obtain multiple columns of binned image patches;

determining horizontal spatial derivatives and vertical spatial derivatives for each binned image patch in each column of the multiple columns of binned image patches;

determining a sharpness metric for each image patch in each column of the multiple columns of binned image patches based on the horizontal spatial derivatives and the vertical spatial derivatives; and

determining the sharpness pattern for each column of the multiple columns of image patches at the plurality of distances from the objective of the microscope based on the sharpness metric for each image patch in a corresponding column of the multiple columns of image patches.

Example 19. In this example, there is provided a computer-implemented method of example 16, wherein determining a sharpness pattern for each column of the multiple columns of image patches captured at the plurality of distances from the objective of the microscope based on the sharpness metric for each image patch in a corresponding column of the multiple columns of image patches comprises:

fitting a function to the sharpness metric for each image patch in the corresponding column of the multiple columns of image patches.

Example 20. In this example, there is provided a computer-implemented method of example 16, further including:

excluding image patches with more than one sharpness peak in corresponding sharpness patterns.

Example 21. In this example, there is provided a computer-implemented method of example 16, wherein the stage of the microscope is connected with a motor actuator, and wherein adjusting a distance between the stage and the objective corresponding to the first focal position of the objective of the microscope comprises causing the motor actuator to move the stage of the microscope to the first focal position of the objective of the microscope.

Example 22. In this example, there is provided a computer-implemented method of example 15, wherein the objective of the microscope is connected with a motor actuator, and wherein adjusting a distance between the stage and the objective corresponding to the first focal position of the objective of the microscope comprises causing the motor actuator to move the objective of the microscope so that the slide on the stage is at the first focal position of the objective of the microscope.

Example 23. In this example, there is provided a non-transitory computer-readable storage device comprising computer-executable instructions that, when executed by a computer system, cause the computer system to perform the method of any of examples 16-22.

Example 24. In this example, there is provided a computer system, including:

a memory configured to store computer-executable instructions; and
a processor configured to access the memory and execute the computer-executable instructions to perform the method of examples 16-22.

Example 25. In this example, there is provided a computer-implemented method, including:

determining a tissue region on a slide based on a pre-captured image of the slide, wherein the slide comprises an unstained tissue sample comprising a plurality of portions;

determining a first portion of the slide based on the tissue region to be scanned;

enabling a camera of a microscope to capture a first set of tissue autofluorescence images of the first portion of the slide at a first plurality of distances from an objective of the microscope;

determining a first focal position of the objective of the microscope for the first portion of the slide based on a first set of sharpness metrics for the first set of tissue autofluorescence images;

enabling the camera of the microscope to capture a first image of the first portion of the slide at the first focal position of the objective of the microscope;

determining a second portion of the slide to be scanned based on a location of the first portion;

enabling the camera of the microscope to capture a second set of tissue autofluorescence images of the second portion of the slide at a second plurality of distances from the objective of the microscope;

determining a second focal position for the second portion of the slide based on a second set of sharpness metrics for the second set of tissue autofluorescence images; and

enabling the camera of the microscope to capture a second image of the first portion of the slide at the second focal position of the objective of the microscope.

Example 26. In this example, there is provided a computer-implemented method of example 25, wherein the second portion is adjacent to the first portion.

Example 27. In this example, there is provided a computer-implemented method of example 25, wherein the second portion of the slide is a neighboring unscanned portion.

Example 28. In this example, there is provided a computer-implemented method of example 25, wherein the first plurality of distances are in a first range of ±130 micrometers around a preset distance, and a step size between the first plurality of distances is about 10 micrometers.

Example 29. In this example, there is provided a computer-implemented method of example 25, wherein the first plurality of distances are in a second range smaller than the first range around the first focal position, and a step size between the second plurality of distances is smaller than 10 micrometers.

Example 30. In this example, there is provided a computer-implemented method of example 25, further including:

determining a figure of merit for each of the plurality of portions based on the pre-captured image;

selecting the portion with a highest figure of merit among the plurality of portions as the first portion; and

selecting a neighboring unscanned portion that has the highest figure of merit among the rest of portions as a next portion to be scanned.

Example 31. In this example, there is provided a computer-implemented method of example 30, further including:

determining that there is no unscanned neighboring portions left; and

selecting a nearest unscanned portion as the next portion to be scanned.

Example 32. In this example, there is provided a computer-implemented method of example 30, further including:

fitting a function to multiple focal positions for multiple portions; and

determining a next focal position for a next portion using the function.

Example 33. In this example, there is provided a computer-implemented method of example 30, wherein determining a first focal position of the objective of the microscope for the first portion of the slide based on a first set of sharpness metrics for the first set of tissue autofluorescence images comprises:

dividing each of the first set of tissue autofluorescence images by a predetermined grid to generate multiple columns of image patches, wherein each column of image patches comprises image patches captured at the plurality of distances from the objective of the microscope;

selecting an image patch of a specific sharpness metric for each column of the multiple columns of image patches to obtain a set of image patches at a corresponding set of focal positions; and

determining a first focal position of the objective of the microscope for the first portion of the slide based on the corresponding set of focal positions.

Example 34. In this example, there is provided a non-transitory computer-readable storage device comprising computer-executable instructions that, when executed by a computer system, cause the computer system to perform the method of any of examples 25-33.

Example 35. In this example, there is provided a computer system, including:

a memory configured to store computer-executable instructions; and

a processor configured to access the memory and execute the computer-executable instructions to perform the method of examples 25-33.

Example 36. In this example, there is provided a computer-implemented method, including:

identifying a tissue region in a pre-captured image of a slide comprising an unstained tissue sample;

selecting multiple portions of the slide based on the tissue region;

enabling a camera of a microscope to capture multiple sets of tissue autofluorescence images for the multiple portions of the slide respectively;

identifying multiple focal positions of an objective of the microscope for the multiple portions of the slide based on sharpness metrics of the multiple sets of tissue autofluorescence images respectively;

fitting a function to the multiple focal positions for the multiple portions of the slide, wherein the function represents a relationship between a focal position of the objective of the microscope for each portion of the slide and a location of each portion of the slide; and

using the function to enable capture of a plurality of image of a plurality of portions of the slide by at least:

adjusting a distance between each portion of the slide and an objective of a microscope to enable the objective of the microscope to be at a primary focal position of each portion of the slide determined from the function based on the location of each portion of the slide; and

causing a camera to capture an image of each portion of the slide at the primary focal position of the objective of the slide.

Example 37. In this example, there is provided a computer-implemented method of example 36, wherein using the function to enable capture of a plurality of image of a plurality of portions of the slide further comprises:

selecting a first portion for image capture from a side of the slide; and

moving a field of view of the microscope from one portion to a next portion in a zig-zag pattern.

Example 38. In this example, there is provided a computer-implemented method of example 36, wherein using the function to enable capture of a plurality of image of a plurality of portions of the slide further comprises:

selecting a first portion for image capture in a center of the tissue region; and

moving a field of view of the microscope from one portion to a next portion in a spiral pattern.

Example 39. In this example, there is provided a non-transitory computer-readable storage device comprising computer-executable instructions that, when executed by a computer system, cause the computer system to perform the method of any of examples 36-38.

Example 40. In this example, there is provided a computer system, including:

a memory configured to store computer-executable instructions; and

a processor configured to access the memory and execute the computer-executable instructions to perform the method of examples 36-38.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computing systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method, comprising:
enabling a camera of a microscope to capture a first set of tissue autofluorescence images of a first portion of a slide at a plurality of distances from an objective of the microscope, wherein the slide comprises an unstained tissue sample, wherein the slide is retained on a stage of the microscope;
dividing each of the first set of tissue autofluorescence images by a predetermined grid to generate multiple columns of image patches, wherein each column of image patches comprises image patches captured at the plurality of distances from the objective of the microscope;
selecting an image patch of a specific sharpness metric for each column of the multiple columns of image patches to obtain a set of image patches and a set of focal positions corresponding to the set of image patches;
determining a first focal position of the objective of the microscope for the first portion of the slide based on the corresponding set of focal positions;
adjusting a distance between the stage and the objective to the first focal position of the objective of the microscope; and
enabling the camera of the microscope to capture a first image of the first portion of the slide when the objective of the microscope is at the first focal position.

2. The computer-implemented method of claim 1, wherein selecting an image patch of a specific sharpness metric for each column of the multiple columns of image patches to obtain a set of image patches and a set of focal positions corresponding to the set of image patches comprises:
selecting an image patch of a maximum sharpness metric for each column of the multiple columns of image patches to obtain the set of image patches and the set of focal positions corresponding to the set of image patches.

3. The computer-implemented method of claim 1, further comprising:
binning each image of the first set of tissue autofluorescence images by a predetermined binning level to obtain a first set of binned tissue autofluorescence images;
dividing the first set of binned tissue autofluorescence images by the predetermined grid to obtain multiple columns of binned image patches;
determining horizontal spatial derivatives and vertical spatial derivatives for each binned image patch in each column of the multiple columns of binned image patches; and
determining a sharpness metric for each image patch in each column of the multiple columns of binned image patches based on the horizontal spatial derivatives and the vertical spatial derivatives.

4. The computer-implemented method of claim 3, further comprising:
determining a spatial frequency range for each binned image based on an exposure time; and
determining the horizontal spatial derivatives and vertical spatial derivatives based on spatial differences horizontally and vertically in each binned image.

5. The computer-implemented method of claim 3, wherein the sharpness metric is based on standard deviations of the horizontal spatial derivatives and the vertical spatial derivatives.

6. The computer-implemented method of claim 3, further comprising:
determining a sharpness pattern for each column of the multiple columns of image patches at the plurality of distances from the objective of the microscope based on the sharpness metric for each image patch in a corresponding column of the multiple columns of image patches.

7. The computer-implemented method of claim 6, wherein determining a sharpness pattern for each column of the multiple columns of image patches captured at the plurality of distances from the objective of the microscope based on the sharpness metric for each image patch in a corresponding column of the multiple columns of image patches comprises:
fitting a function to the sharpness metric for each image patch in the corresponding column of the multiple columns of image patches.

8. The computer-implemented method of claim 1, wherein selecting an image patch of a specific sharpness metric for each column of the multiple columns of image patches to obtain a set of image patches at a corresponding set of focal positions comprises excluding image patches having a corresponding sharpness pattern that comprises more than one sharpness peak.

9. The computer-implemented method of claim 1, further comprising, prior to selecting an image patch of a specific sharpness metric for each column of the multiple columns of image patches to obtain a set of image patches at a corresponding set of focal positions, excluding image patches from the multiple columns of image patches with a brightness below a threshold.

10. The computer-implemented method of claim 1, wherein determining a first focal position for the first portion of the slide based on the corresponding set of focal positions comprises:
determining a mode of the corresponding set of focal positions to be the first focal position for the first portion of the slide.

11. The computer-implemented method of claim 1, wherein determining a first focal position for the first portion of the slide based on the corresponding set of focal positions comprises:
determining a median of the corresponding set of focal positions to be the first focal position for the first portion of the slide.

12. The computer-implemented method of claim 1, wherein the stage of the microscope is connected with a motor actuator, and wherein adjusting a distance between the stage and the objective corresponding to the first focal position of the objective of the microscope comprises causing the motor actuator to move the stage of the microscope to the first focal position of the objective of the microscope.

13. The computer-implemented method of claim 1, wherein the objective of the microscope is connected with a motor actuator, and wherein adjusting a distance between the stage and the objective corresponding to the first focal position of the objective of the microscope comprises causing the motor actuator to move the objective of the microscope so that the slide on the stage is at the first focal position of the objective of the microscope.

14. A non-transitory computer-readable storage device comprising computer-executable instructions that, when executed by a computer system, cause the computer system to perform operations comprising:
enabling a camera of a microscope to capture a first set of tissue autofluorescence images of a first portion of a slide at a plurality of distances from an objective of the microscope, wherein the slide comprises an unstained tissue sample, wherein the slide is retained on a stage of the microscope;
dividing each of the first set of tissue autofluorescence images by a predetermined grid to generate multiple columns of image patches, wherein each column of image patches comprises image patches captured at the plurality of distances from the objective of the microscope;
selecting an image patch of a specific sharpness metric for each column of the multiple columns of image patches to obtain a set of image patches and a set of focal positions corresponding to the set of image patches;
determining a first focal position of the objective of the microscope for the first portion of the slide based on the corresponding set of focal positions;
adjusting a distance between the stage and the objective to the first focal position of the objective of the microscope; and
enabling the camera of the microscope to capture a first image of the first portion of the slide when the objective of the microscope is at the first focal position.

15. A non-transitory computer-readable storage device of claim 14, wherein the operations further comprise:
selecting an image patch of a maximum sharpness metric for each column of the multiple columns of image patches to obtain the set of image patches and the set of focal positions corresponding to the set of image patches.

16. A non-transitory computer-readable storage device of claim 14, wherein the operations further comprise:
binning each image of the first set of tissue autofluorescence images by a predetermined binning level to obtain a first set of binned tissue autofluorescence images;
dividing the first set of binned tissue autofluorescence images by the predetermined grid to obtain multiple columns of binned image patches;
determining horizontal spatial derivatives and vertical spatial derivatives for each binned image patch in each column of the multiple columns of binned image patches; and
determining a sharpness metric for each image patch in each column of the multiple columns of binned image patches based on the horizontal spatial derivatives and the vertical spatial derivatives.

17. A non-transitory computer-readable storage device of claim 16, wherein the operations further comprise:
determining a sharpness pattern for each column of the multiple columns of image patches at the plurality of distances from the objective of the microscope by fitting a function to the sharpness metric for each image patch in each column of the multiple columns of image patches.

18. A computer system, comprising:
a memory configured to store computer-executable instructions; and
a processor configured to access the memory and execute the computer-executable instructions to perform operations comprising:
enabling a camera of a microscope to capture a first set of tissue autofluorescence images of a first portion of a slide at a plurality of distances from an objective of the microscope, wherein the slide comprises an unstained tissue sample, wherein the slide is retained on a stage of the microscope;
dividing each of the first set of tissue autofluorescence images by a predetermined grid to generate multiple columns of image patches, wherein each column of image patches comprises image patches captured at the plurality of distances from the objective of the microscope;
selecting an image patch of a specific sharpness metric for each column of the multiple columns of image patches to obtain a set of image patches and a set of focal positions corresponding to the set of image patches;
determining a first focal position of the objective of the microscope for the first portion of the slide based on the corresponding set of focal positions;
adjusting a distance between the stage and the objective to the first focal position of the objective of the microscope; and
enabling the camera of the microscope to capture a first image of the first portion of the slide when the objective of the microscope is at the first focal position.

19. The computer system of claim 18, wherein selecting an image patch of a specific sharpness metric for each column of the multiple columns of image patches to obtain a set of image patches at a corresponding set of focal positions comprises excluding image patches having a corresponding sharpness pattern that comprises more than one sharpness peak.

20. The computer system of claim 18, wherein the operations further comprise, prior to selecting an image patch of a specific sharpness metric for each column of the multiple columns of image patches to obtain a set of image patches at a corresponding set of focal positions, excluding image patches from the multiple columns of image patches with a brightness below a threshold.
